(19) United States
(12) Patent Application Publication
(10) Pub. No.: US 2002/0035484 A1
(43) Pub. Date: Mar. 21, 2002

(54) SYSTEM AND METHOD OF GENERATING A MEDICATION PRESCRIPTION

(75) Inventor: JOSEPH MCCORMICK, PORT JEFFERSON STATION, NY (US)

Correspondence Address: SYMBOL TECHNOLOGIES INC, LEGAL DEPARTMENT, ONE SYMBOL PLAZA, HOLTSVILLE, NY, 11742, US

(73) Assignee: GLENN F FRANKENBERGER

(21) Appl. No.: 09/290,646

(22) Filed: Apr. 12, 1999

(51) Int. Cl. G06F 17/60

(52) U.S. Cl. 705/2

(57) ABSTRACT

System and method are provided wherein a physician uses a handheld terminal to tap and select a prescription. At the time of writing the prescription, the terminal has information regarding the patient's drug insurance benefits (formulary compliance), as well as other patient medical history such as medications that the patient may currently be taking (drug utilization review) and any allergies. This patient information may be provided to the terminal from a database through the Web, a modem or an access point. Using this information the physician is able to provide the optimal patient prescription. The terminal has capabilities for voice recognition, biometric identification and GPS locator so that the prescribing physician's identity and location can be positively identified. The positive physician identification (biometric) and positive physician location (GPS) are important because in a wireless wide area network environment, only the authorized physician may prescribe drugs and route drugs in the state the physician is licensed in. The prescription is printed out to a printer connected to the terminal by infra-red at the time of the prescribing so that one print-out is given to the patient and another fixed to the patient's chart. The prescription is printed in regular alphanumeric letters as well as encoded in a machine readable code, such as PDF 417 or encoded in a smart card so that when it is brought to the pharmacy, the prescription data are automatically entered, reducing human errors. A refill notice is sent out to the patient, wherein the refill notice has the most recent formulary compliance and drug utilization review information in machine readable code so that the patient can take that information to the next visit to the physician's office. The machine readable code may also include the diagnoses for which the drugs are being prescribed and the insurance companies may use this information to selectively authorize use of certain drugs.

### BACKGROUND OF THE INVENTION

A. Field of the Invention

The present invention relates to systems and methods for a physician to generate a medication prescription.

B. Description of the Related Art

A majority of visits to the doctor's office result in the physician writing a prescription for the patient, and the patient taking the prescription to a local pharmacy to get the drug prescribed. There are several short-comings in this traditional prescription writing approach.

First, as most patients routinely experience; the physician's hand-written prescription is often illegible. An experienced pharmacist may be able to decipher most hand-written prescriptions from their experience. However, at least three kinds of errors and inefficiencies are bound to happen at the pharmacy on a regular basis: (a) the pharmacist is unable to read and has to call the doctor's office, wasting both the doctor's and the pharmacist's time; (b) the pharmacist misreads the prescription and gives the wrong drug to the patient, with potentially catastrophic results; or (c) the pharmacist can read the physician's prescription, but makes a mistake in manually typing in the prescription to the pharmacy's computer and gives the wrong drug to the patient. All of these errors cause inefficiencies and have the potential for disastrous consequences to the patient, the physician, the pharmacist, as well as to the health care industry at large.

Second, there are inefficiencies at the doctor's office in generating the prescription. At the time of writing the prescription, the physician generally does not have the full information on what other drugs the patient may be taking. Some drugs that the patient is currently taking or has recently taken may adversely interact with the drug the physician is about to prescribe to the patient. Many patients do not have this information and even if a patient is able to provide some of that information, that information may not be complete or reliable. This inability to check for the possible adverse drug interaction, referred to as DUR or Drug Utilization Review, at the time of writing the prescription waste time and money in a variety of ways: (a) in the most extreme situation, the patient having been prescribed and having taken incompatible drugs may suffer serious medical consequences, sometimes even death; and (b) even if the drug incompatibility is discovered by the pharmacist, the pharmacist has to call the doctor's office because the pharmacist cannot give a substitute drug without the doctor's authorization.

Third, it would also be useful for the physician to have patient's other medical history. For example, the patient may have allergies with respect to certain types of drugs. Additionally, the patient's medical history may indicate that certain drugs, even though harmless, do not have the desired or intended effect on the patient. Thus, having the patient's medical history enables the physician to prescribe more appropriate drugs to the patient.

Fourth, at the time of writing the prescription, the physician does not know whether the particular drug being prescribed is covered by the patient's insurance policy. If the drug is not (or covered but not preferred by the insurance company), the patient will incur unnecessary expense and the insurance company may also incur additional expenses. Thus, it would be beneficial for the physician to have access to and follow the preferred drug guidelines of the patient's insurance company. This is referred to as formulary compliance—complying with the preferred drug guidelines of the particular insurance company.

There have been proposed prescription related systems, such as the one disclosed in U.S. Pat. No. 5,845,255 and uses of machine readable codes related to a physician's prescribing activities, such as the one disclosed in 2D Customer Updates: PDF 417 Speeds Spanish Prescription Processing, 2D News, Vol. 2, Issue 2 (July 1997).

U.S. Pat. No. 5,845,255, which is herein incorporated by reference, discloses a system wherein a physician uses a handheld device to generate a prescription. The device is wirelessly connected to a central database, and is able to check drug utilization and formulary compliance. The prescription itself is either electronically sent to a pharmacy (requiring that the pharmacy and the physician's office to be linked to a network) or printed out and given to the patient. However, this system fails to provide for, among others, printing a machine readable prescription for the patient to take to a local pharmacist and be read automatically by a machine. Thus, the pharmacist still has to manually type in the prescription. Thus, while the prescription is legible, this system requires cumbersome manual data entry and is subject to the human data entry errors. Furthermore, this device can only work where the doctor's office has a communications link with a central database.

2D Customer Updates: PDF 417 Speeds Spanish Prescription Processing, 2D News, Vol. 2, Issue 2 (July 1997), which was published by the current assignee of this application, Symbol Technologies, Inc., and which is herein incorporated by reference, discloses a small portable system in a carrying case, containing a terminal with a magstripe reader and a portable printer. If drugs need to be prescribed during a patient visit, the doctor swipes in the patient's heath care identification card using the magstripe reader. The terminal then prints out on the portable printer, which is connected to the printer through a cable, a two-dimensional bar code (referred to as PDF 417) label containing both the patient and doctor identifying information. However, the details of the medication being prescribed are hand-written and must be deciphered and manually typed in by the pharmacist, and thus this system is subject to the human errors described above.

### SUMMARY OF THE INVENTION

Therefore, the proposals of the related art fail to comprehensively overcome the problems discussed above and other related problems. Advantages of this invention will be set forth in part in the description which follows, and in part will be obvious from the description, or may be learned by practice of the invention. The advantages of the invention will be realized and attained by means of the elements and combinations particularly pointed out in the appended claims.

In accordance with the purpose of the invention, as embodied and broadly described herein, the invention comprises: a computer aided method of generating a medication prescription, including the steps of: (a) entering a medication prescription into a terminal; (b) checking at the point of prescribing the medication prescription with a database for formulary compliance; (c) printing the prescription recorded in the terminal in a machine readable code on a printer connected to the terminal by infrared; and (d) automatically scanning the machine readable code at a pharmacy to fill the prescription.

In another embodiment, the invention comprises: a computer aided method of generating a medication prescription, including the steps of: (a) entering a medication prescription and a diagnosis into a terminal; (b) checking at the point of prescribing the medication prescription with a database for formulary compliance; and (c) printing the prescription and the diagnosis recorded in the terminal in a machine readable code on a printer.

In yet another embodiment, the invention comprises: a computer aided method of generating a medication prescription, comprising: (a) entering a medication prescription and a diagnosis into a terminal; (b) printing the prescription including the drug information and the diagnosis recorded in the terminal in a machine readable code on a printer.

In a further embodiment, the invention comprises: a computer aided method of generating a medication prescription, including the steps of: (a) scanning in a machine readable code having information regarding a patient related information for prescription writing purposes, including drug formulary information; and (b) generating a medication prescription in accordance with the information derived from the machine readable code.

In another embodiment, the invention comprises: a system for generating a medication prescription, including: (a) a computer including a database, the database comprising: a list of participating insurance carriers, a list of members for each of the participating insurance carriers, and a list of drugs approved for each member by each of the participating insurance carriers; (b) a communications link; (c) a terminal communicating with the computer through the communications link, the terminal including: input means for a prescriber to enter a prescription, a first communication module for communication with the computer through the communications link, a second communication module, and a terminal software for allowing the prescriber to enter patient data, a desired prescription and to communicate the patient data to the computer and return information to the terminal and display the information; and (d) a printer for printing the prescription including the drug information in a machine-readable code, the printer wirelessly communicating with the terminal through the second communication module.

In another embodiment, the invention comprises: a system for generating a medication prescription, comprising: (a) a pen-based handheld terminal, including: input means for an authorized prescriber to enter a prescription and for capturing the prescriber's signature and a wireless module; and (b) a printer for printing the prescription including the drug information in a machine-readable code, the printer wirelessly communicating with the terminal through the wireless module.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1A is the sequence of events in a visit to the doctor's that results in a prescription according to the prior art.

FIG. 1B is the sequence of events in a visit to the doctor's that results in a prescription in accordance with the principles of the present invention.

FIG. 2 is a block diagram depicting the principal components of a system in accordance with the principles of the invention.

FIG. 3A is a plan view of one type of portable terminal that may be used in conjunction with the present invention.

FIG. 3B is a side view of the portable terminal of FIG. 3A.

FIG. 4 are samples screens showing what a typical prescribing activity will entail according to the principles of the invention.

FIG. 5 is one of the final screens shown on the handheld terminal during the physician's prescription writing process.

FIG. 6 illustrates how an actual prescription may be printed in a patient room.

FIG. 7 is a sample prescription printed out in accordance with the principles of the present invention.

FIG. 8 is a block diagram of a system comprising a keyboard, a monitor and a computer that may be used by a receptionist and/or a pharmacist.

FIGS. 9A and 9B are screens of a hand terminal showing the possible drugs available according to the drug formulary requirements.

FIG. 10 is a sample super bill that a physician typically fills out to record the procedures performed and diagnoses of the patient conditions for insurance payment purposes.

FIG. 11 is a sample prescription including diagnosis codes printed out in accordance with the principles of the present invention.

FIG. 12 is the sequence of events in a visit to the doctor's that uses a batch handheld terminal to generate a prescription in accordance with the principles of the present invention.

FIG. 13 is another sample prescription in accordance with the principles of the present invention.

### DETAILED DESCRIPTION OF THE EMBODIMENTS

Reference will now be made in detail to the embodiments of the invention, examples of which are illustrated in the accompanying drawings. Wherever possible, the same reference numbers will be used throughout the drawings to refer to the same or like parts.

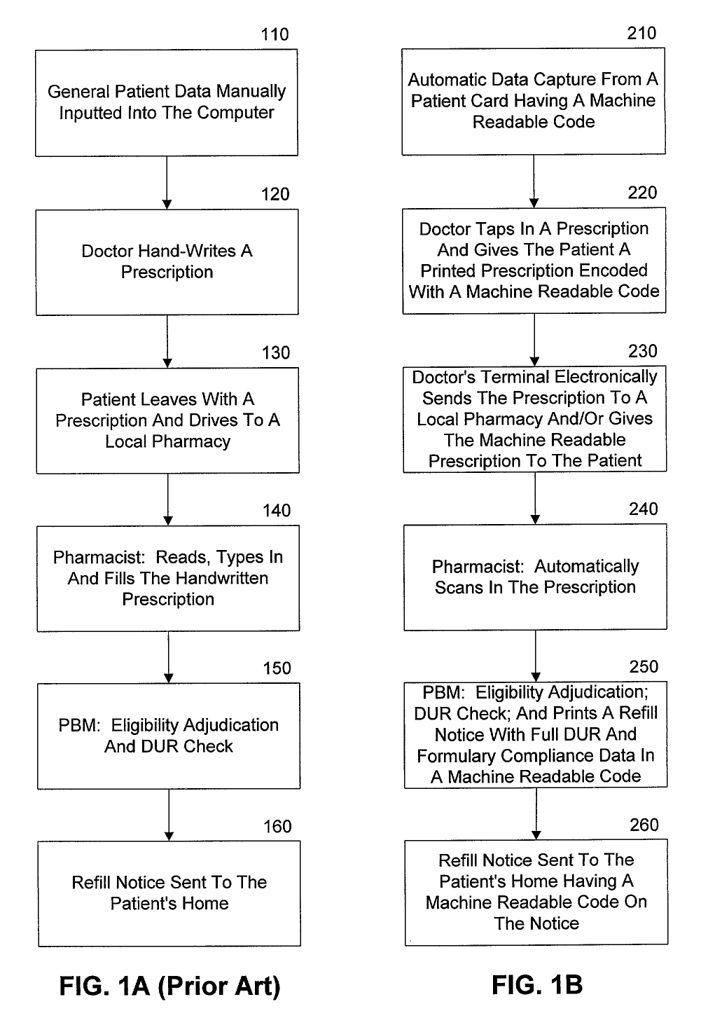

FIGS. 1A and 1B illustrate two sequences of events in a visit to the doctor's that results in a prescription. The first sequence in FIG. 1A shows what happens in the traditional, manual prescription writing and FIG. 1B depicts the process of generating a machine-readable medication prescription in accordance with the principles of this invention.

In FIG. 1A, the patient visits the doctor and is greeted by the receptionist. In step 110, various general patient data, such as the name, social security number, insurance company name, insurance company phone number and modem number, are generally filled out by the patient and given to the receptionist (or some other clerk or nurse), who in turn, generally types in the patient data into a computer manually. A patient folder is created by the receptionist and substantially the same general patient data are either handwritten into or printed and inserted into the folder.

In step 120, the doctor examines the patient and hand-writes a prescription for the symptoms the patient is complaining of. The doctor generally writes some notes into the patient folder, summarizing the diagnoses and the procedures taken and the prescription being given.

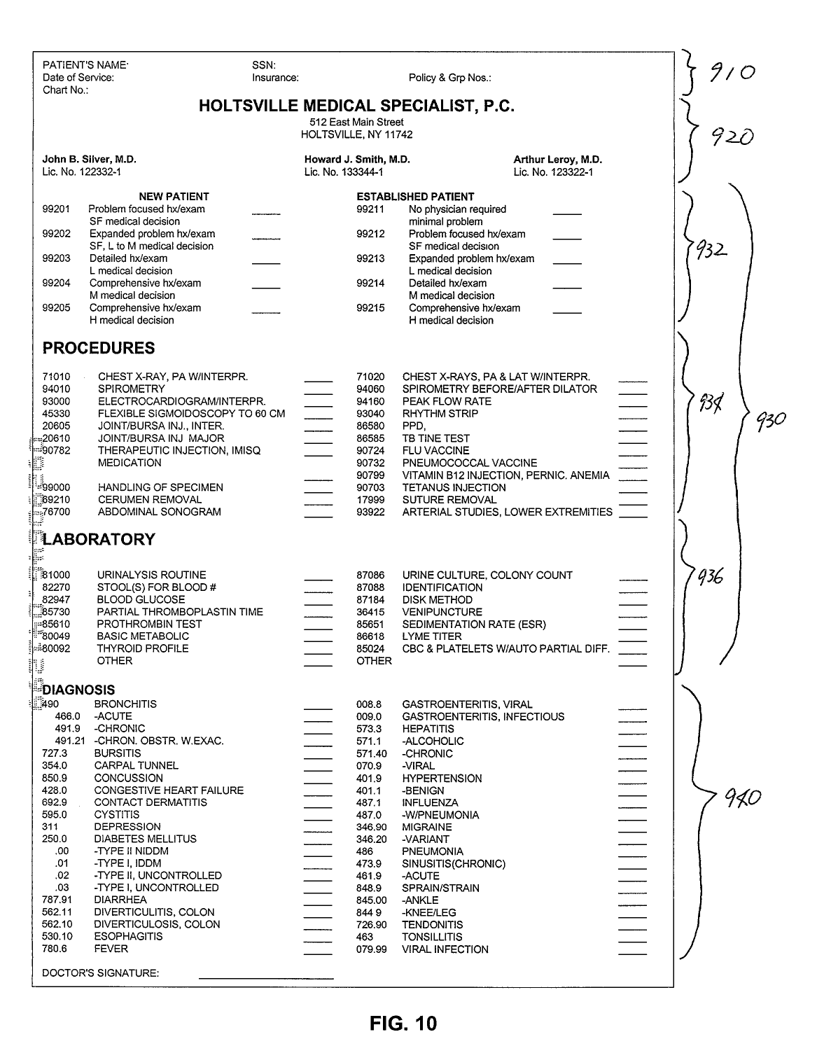

The diagnoses and procedures are generally noted in what is referred to as a super bill. An example of such a super bill is shown in FIG. 10. The super bill of FIG. 10 broadly has four sections 910, 920, 930 and 940. Section 910 includes the patient related information, such as the patient's name, social security number, date of service, patient chart number, insurance company name, insurance policy and group numbers. Section 920 includes the doctor related information such as the name of the physician's office, address, names of the doctors at the office and their license numbers. Section 930 shows the services or procedures being provided at the doctor's office, and has three subsections: patient encounter level 932, general procedures 934 and laboratory procedures 936. These subsections in essence describe the amount and nature of medical services provided by the doctor and the doctor's office to the patient. For ease of insurance claim purposes, each of these services is assigned a code. While there are other coding schemes for medical procedures, the CPT code is probably most widely used. CPT is an acronym for Current Procedural Terminology and is a listing of over 7,000 codes and descriptions used for reporting medical services and procedures performed by physicians and other medical professions. The purpose of the coding system is to provide a uniform language that accurately describes medical services and provides an effective means for reliable nationwide communication among physicians, patients, and insurance carriers. Generally, the insurance companies pay the doctors according to the procedures performed by the doctors as captured according to the CPT codes.

Patient encounter level subsection 932 describes the level of medical service being provided by the doctor. Generally, the more involved the encounter, the higher the doctor will be reimbursed. For example, the doctor may be paid by the insurance company according to the following schedule:

| | | |
|---|---|---|
| 99201 | Problem focused hx (history) & exam - 10 min | $45.70 |
| | straight forward med decision | |
| 99202 | Expanded problem hx & exam - 20 min | $53.53 |
| | straightforward med decision - low to moderate | |
| | severity | |
| 99203 | Detailed hx & exam - 30 min -medical | $63.61 |
| | decision of low complexity | |
| 99204 | Comprehensive hx & exam - 45 min | $81.97 |
| | medical decision of moderate complexity | |
| 99205 | Comprehensive hx & exam - 60 min | $86.23 |
| | medical decision of high complexity | |

In addition to the patient encounter level, the doctor is compensated for additional medical procedures performed. In the super bill, these procedures are recorded under subsections (general procedures) and 936 (laboratory procedures).

The fourth section shows the diagnoses for the patient's condition. Like the CPT codes for the procedures, the doctor is required to fill out the codes for the diagnoses. The codes often used for diagnoses is the International Classification of Diseases, 9th Revision (ICD-9). ICD-9 is designed for the classification of patient morbidity (sickness) and mortality information for statistical purposes and for the indexing of hospital records by disease and operation for data storage and retrieval. The doctor does not get paid by the insurance companies for the diagnoses, but only paid for the procedures performed. However, the doctor is required to enter the diagnoses information for proper payment on the procedures performed. For example, if the procedure performed was sigmoidoscopy (a rectal colon cancer screening test; CPT procedure code 45330), and if the doctor noted a diagnosis of abdominal pain (ICD-9 code 789.00), then the insurance company may refuse payment because the diagnosis was too general and the procedure was not authorized for such a general diagnosis. On the other hand, if the doctor noted a more specific diagnosis of diverticulitis (ICD-9 code 56211), the insurance company would make the payment. Thus, each insurance company authorizes certain procedures for certain diagnoses and the doctor must follow those guidelines for full payment.

In step 130, the patient leaves with the hand-written prescription and drives to a local retail pharmacy. In step 140, the pharmacist deciphers the doctor's handwriting, manually types in and fills the prescription. This manual data entry results in at least three types of errors and/or inefficiencies: (a) the pharmacist is unable to decipher the handwritten prescription and has to call the doctor's office, wasting both the doctor's and the pharmacist's time; (b) the pharmacist misreads the prescription and gives the wrong drugs to the patient, with potentially catastrophic results; or (c) the pharmacist can read the physician's prescription, but makes a mistake in manually typing in the prescription to the pharmacy's computer and gives the wrong drug to the patient.

In step 150, the pharmacy communicates with a pharmacy benefit management company (“PBM”) to determine eligibility adjudication and drug utilization review (“DUR”) check. A PBM generally works as a clearing house of insurance companies and has a database of information such as a list of insurance companies, the list of members in each insurance company, the benefit information for each member and the preferred drug list provided by each insurance company. This database is relational in that the relevant information are interlinked to each other. For example, when a member name or member identification number is inputted, the database outputs other information such as the benefit information for each member and the eligible drug list. The PBM is generally electronically linked to several of the major pharmacy chains through a modem. Note that the formulary compliance information for each member (that is, what kind or brand of drugs are free or relatively inexpensive for the patient) and the drug utilization review information (that is, what drugs the patient is taking currently or what drugs the patient may be allergic to) are available only to the pharmacy and not to the doctor at the time of writing the prescription. This lack of information at the doctor's office results in the patient incurring unnecessary additional expenses and sometimes in the pharmacist having to call the doctor's office for another, substitute prescription.

In step 160, for chronic patients, the PBM sends to the patient's home a refill notice, reminding the patient to return to the pharmacy for a refill.

FIG. 1B is an overview of the sequence of events for generating a machine-readable prescription in accordance with the principles of the present invention. The more detailed description on each of the components is discussed below in conjunctions with the figures below. In step 210, the patient comes to the doctor's office and shows the receptionist a patient card with machine readable code on it with general patient data such as the name, social security number, insurance company name, insurance company phone number, modem number, copayment information, the insured's name, policy number and group ID number. The patient card may include: a two-dimensional bar code (such as PDF 417 developed by Symbol Technologies, Inc., the assignee of this patent application), radio frequency identification (“RFID”) tag, smart card circuitry, or magstripe or other machine readable code. The patient data are thus automatically entered into the computer when the receptionist scans in the patient card. The patient data, in turn, are printed on a label and attached to the patient folder. This patient folder label may also have the machine readable code (such as PDF 417) on it so that the general patient data could be scanned in later from the patient folder for other uses. For example, the machine readable code on the patient folder may be used to autopopulate fields in the insurance and other standard forms.

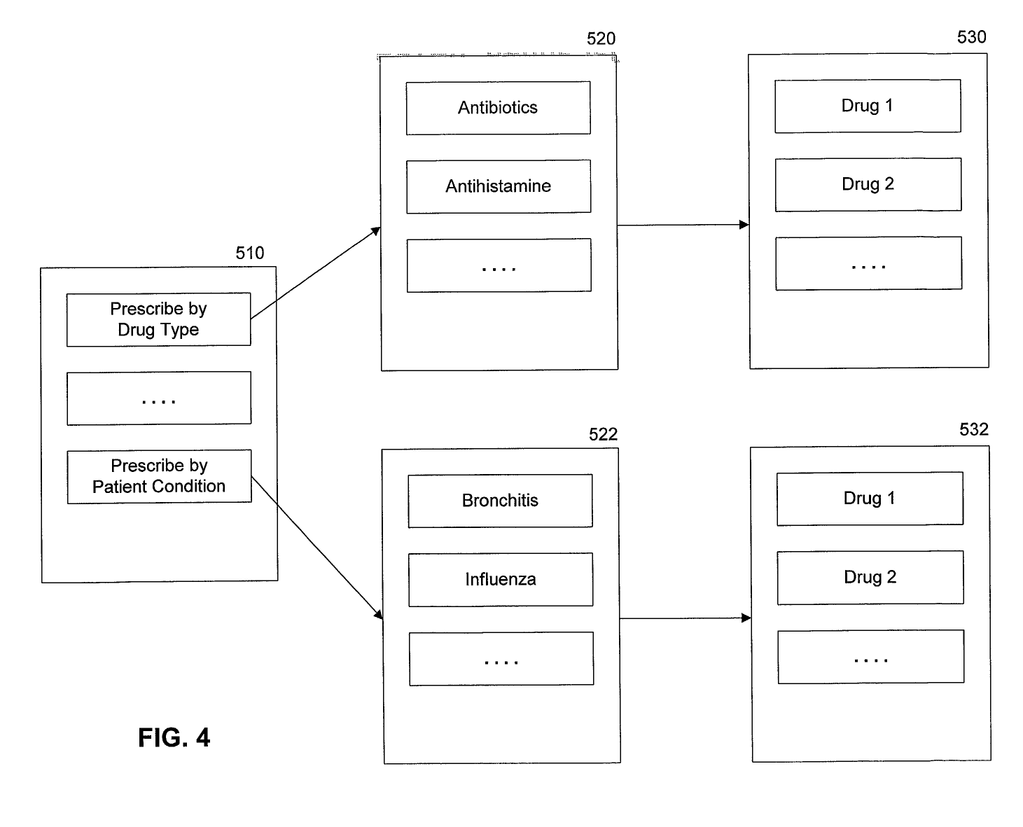

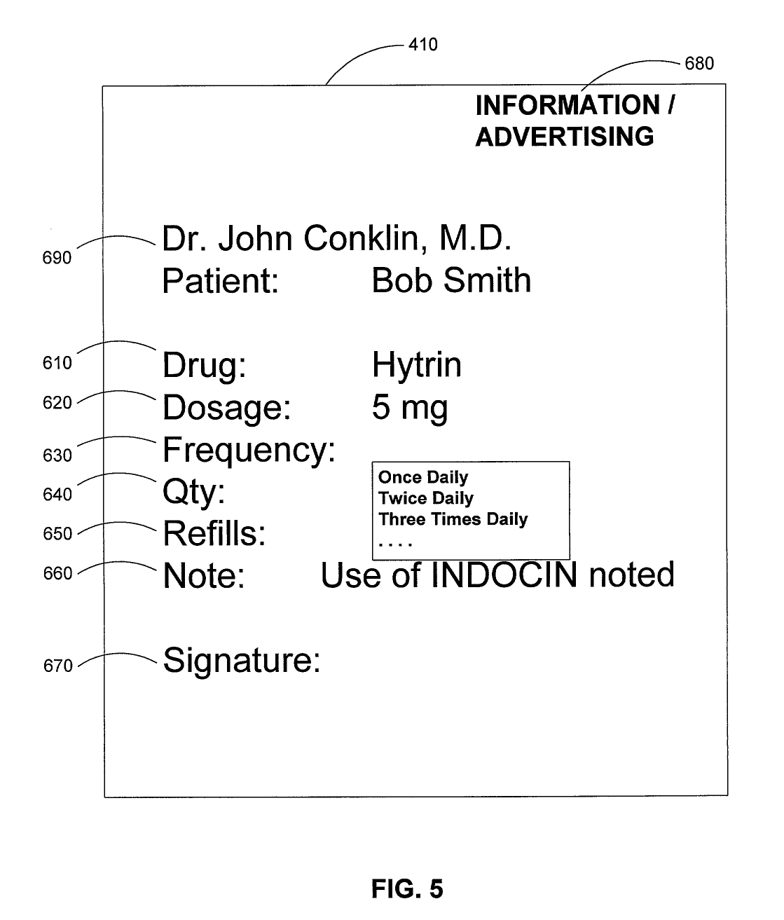

In step 220, the doctor greets the patient in the patient room. The doctor carries a handheld terminal, which optionally includes a machine-readable code reader such as a 2D bar code reader and/or a magstripe reader, and uses this handheld terminal to “tap” in the prescription. The details of this “tapping” a prescription are described below in conjunction with FIGS. 4 and 5 and the corresponding text. Briefly, instead of having to hand-write any text, the doctor reviews the menu of items displayed by the handheld device and just taps to select the desired menu item. For example, when the doctor taps on the “PRESCRIPTION” program on the handheld terminal, the terminal displays a number of available menu items, such as types of drugs (e.g., pain relievers, antibiotics and antihistamines) as icons either in the text or graphic format. When the particular type of drugs, such as antibiotics, is selected by the physician tapping on the displayed icon, then the PRESCRIPTION program further displays specific antibiotics. By using such a tapping method, the doctor inputs all the necessary information for writing a prescription: the drug name, dosage, frequency of intake, quantity, refill information and any other relevant information. As described in detail below, text information may also be “handwritten” using a type of handwriting recognition, such as the Graffiti used on Palm III™ distributed by 3Com.

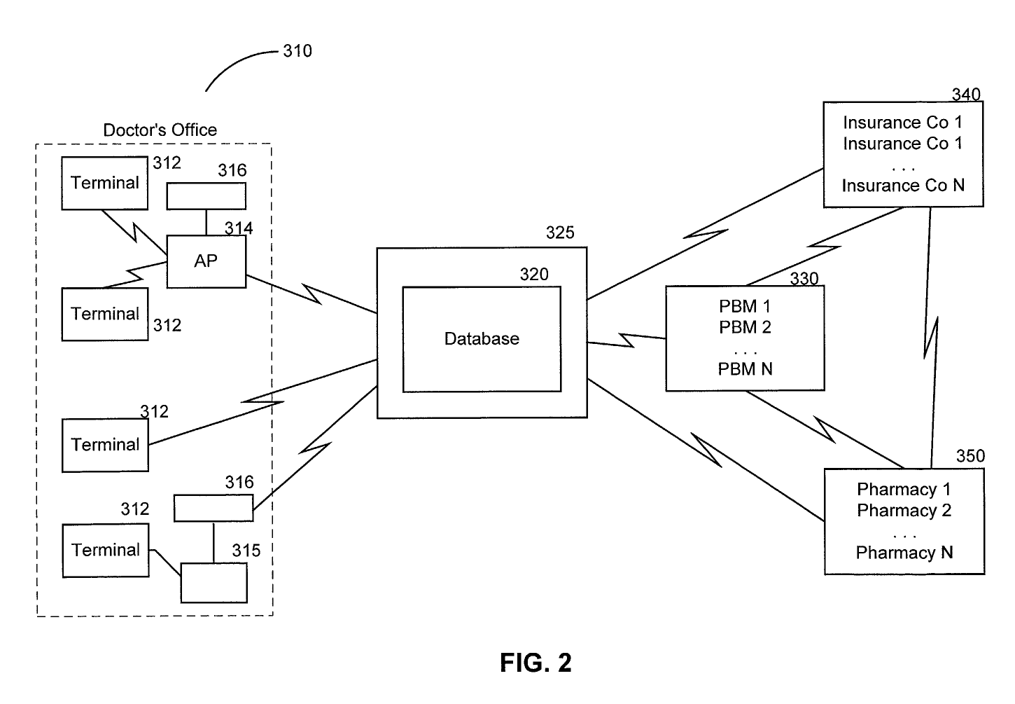

Also, in step 220, at the time of the prescription writing, the information from the PBM is available to the doctor through the terminal via a communications link. The details of the communication link are described below in conjunction with FIG. 2. With the access to the PBM information, the doctor can ensure that (1) the drug being prescribed is covered and/or preferred by the patient's insurance policy (drug formulary compliance), resulting in lower costs for the patient and the insurance company; (2) the drug being prescribed will not adversely interact with any other medication that the patient is currently taking (DUR—Drug Utilization Review); and (3) the drug being prescribed is consistent with the patient's prior medical history (such as any drugs the patient may be allergic to or any drugs that are particularly more or less effective on the individual patient).

Note that the information from the PBM (e.g., allergy information, drugs being taken currently and other medical history) may also be available to the receptionist. Thus, during the patient check-in process, the receptionist may print out this information and put the print-out into the patient folder for the doctor's review.

The data from the PBM may also provide helpful professional assistance for the doctor. This can take two forms: doctor-initiated and the source-initiated. In the doctor-initiated case, for example, the doctor may request information on a new drug that he or she heard and is willing to try. Also, the doctor may be interested in such information as the top five most prescribed drug for a particular condition that a patient has. The doctor may also be interested in what other conditions the patient is currently being treated for and with the patient's consent, may access this information from the central database. This additional information not only allows the physician to provide a more intelligent choice of drug for the patient, but also the same doctor may be able to treat the patient for those other conditions, making it more convenient for the patient.

In the source-initiated cases, the source of the information may send the information to the doctors without the doctors' request. For example, a drug company may wish to reach quickly to the doctors some information regarding previously-unknown side effects of a particular drug. Other such source-initiated cases may involve a form of additional educational information, advertising and infomercials. Such source-initiated information may be continuously displayed at a particular area of the terminal's screen. In one business model, the sources (e.g., drug companies) may be willing to buy the advertising area of the terminal screen, and such money may go toward providing the terminals for free to the doctors. The sponsoring companies (such as drug companies) may have “soft buttons” (or physical buttons) on the terminal screen when pressed would give the physician company and/or drug related information.

Throughout the most of this application, it is assumed that the relevant information (formulary, medical history etc.) comes from the PBM. However, it will be understood that this information can be assembled, kept and/or provided by other entities such as the insurance company or by a separate, independent entity. Thus, whenever this application indicates that certain information comes from the PBM, it will be understood that that information may come from the insurance company, a financial institution, or a separate entity.

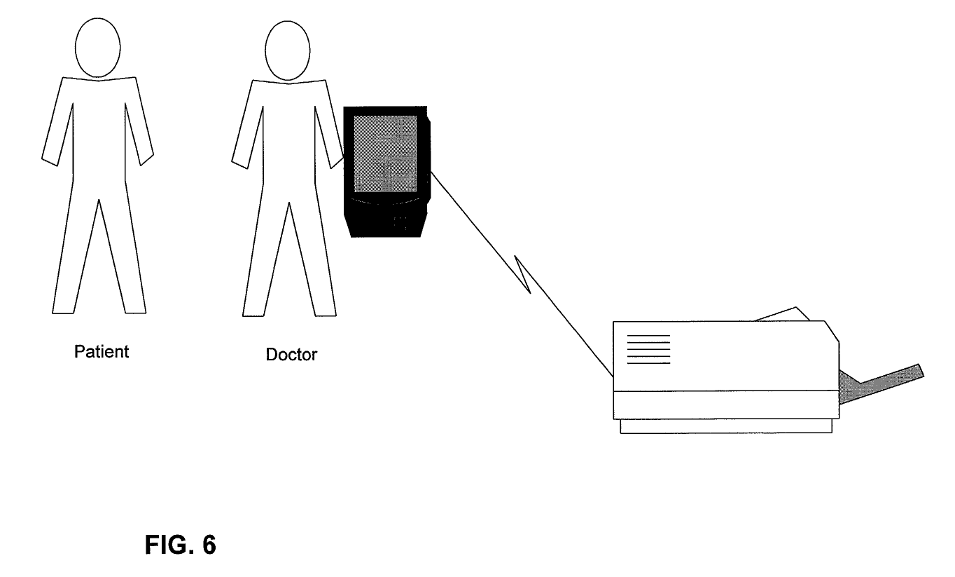

In step 230, the doctor may ask the patient where and how to fill the prescription. The patient may already have a regular local pharmacy that he or she goes to. Alternatively, the patient may be unfamiliar with local pharmacies and the doctor may be able to suggest a pharmacy. The doctor's terminal can display a map showing multiple pharmacies and the patient may be able to select one from the map. Once the pharmacy is selected, the terminal will also be able to print out the map and the directions to the local pharmacy. Details of the printing operation is described below in conjunction with FIG. 6. Such map and direction information may either reside in the local terminal memory or may be sent from the remote database. For example, in a press release dated Dec. 2, 1998, 3Com has announced a national field trial of Palm VII™, which is a handheld device with a wide area two-way radio, providing access to a number of Web sites. One of the links could easily be made to a map service showing all the pharmacies.

The patient may also be interested having the drugs (all or some) sent to his or her home by mail order, which generally is less expensive than buying it retail at a local pharmacy. The doctor's terminal has the option whereby part of the prescription is to be filled by a local pharmacy and the rest to be sent by mail to the patient's home.

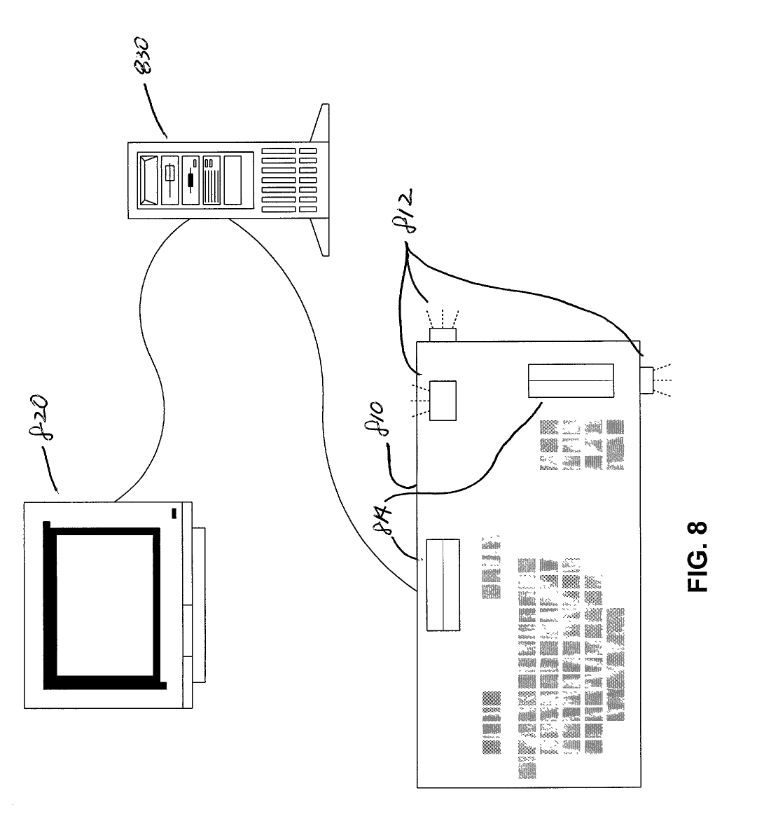

In step 240, the pharmacist at the local pharmacy receives the prescription from the patient. The pharmacist scans the machine readable code into his or her computer. This reduces the prescription fill time in the following ways: (1) reduces time in having to decipher the otherwise handwritten prescription; and (2) reduces data entry time (manual typing vs. automatic scanning). The automatic data entry has the following additional advantages: (1) reduced fill errors, wherein any prescription fill error could potentially have disastrous and expensive consequences; (2) lower fill cost due to better efficiency; (3) better customer service (faster service and shorter line); and (4) competitive advantage (not having the automated data entry would have a negative customer image). FIG. 8 and the corresponding description below describe the details of a terminal that may be used by a pharmacist.

In step 250, the pharmacy communicates with the PBM to optionally check the DUR information and the formulary compliance information. This DUR and formulary check is optional since presumably the prescription was already based on relatively current DUR and formulary information. The PBM also adjudicates the claim in real time and sends back to the pharmacy the amount that the patient is responsible for and indicates how much the insurance company will pay for. The PBM then arranges either directly with individual insurance companies or through financial institutions for payment to the pharmacies. The communications link between the pharmacy and the PBM could be a telephone modem, a cable modem, the Internet (with the Web based browser), or any other communications link.

In step 260, the PBM sends by mail (or e-mail) the refill notice to the patient at the patient's home. The refill notice may include a machine readable code containing information such as the full DUR information (e.g., drugs currently being taken by the patient) and the formulary compliance information (e.g., the list of preferred drugs) of the patient's insurance company and any other relevant medical history.

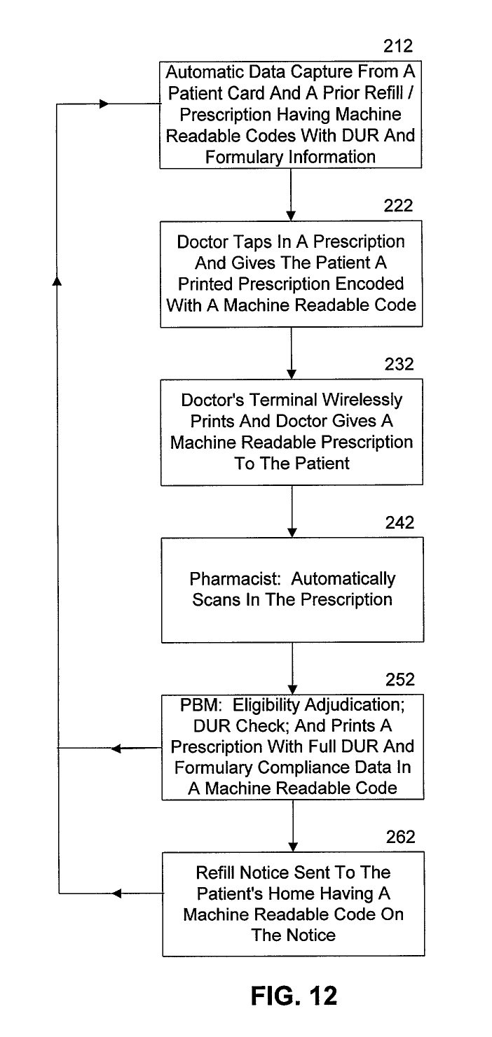

This DUR, formulary and other medical history information in the machine readable code may be provided either in step 250 of FIG. 1B (by the pharmacist after he or she checks DUR, formulary and other medical information with the PBM) or in step 260 of FIG. 1B (refill notice from the PBM). Having the DUR, formulary and/or other medical information allows a variation to the present invention, wherein the doctor's office does not need to have a communications link with the PBM. This variation is illustrated in FIG. 12. Note that by bringing the last prescription from the pharmacy or the latest refill notice from the PBM (having a machine readable code with the DUR, formulary and other medical history) to the next doctor's visit, the patient can provide to the doctor, essentially all of the latest DUR, formulary and/or other medical information to the doctor (in step 212) without the doctor having to communicate to any outside entity such as the PBM. Thus, even if the doctor's office is not electronically linked to the PBM, the doctor has relatively reliable DUR and formulary information at the time of writing a new prescription.

FIG. 2 shows the principal components of a system in accordance with the principles of the invention. Database 320 may include: (1) insurance company related information, such as the list of insurance companies, the names of the members of the insurance companies, the formulary information for each member and other member information such as copayments; (2) the patient related information such as the DUR information for each member/patient and any additional member information such as allergies and other medical history; and (3) drug company related information, such as educational or advertising information regarding specific drugs and other information originated from a drug company. In one embodiment of the present invention, database 320 is created and maintained by a clearing house with links to Pharmacy Benefit Management companies (“PBMs”), insurance companies and pharmacies, but it may be created and maintained by the PBM's, or other health care entities, such as the insurance companies, as well. In FIG. 2, database 320 at the clearing house 325 is shown as linked to PBMs, as well as Insurance Companies 340 and Pharmacies 350. As indicated by the lines, PBMs 330, Insurance Companies 340 and Pharmacies 350 may be linked to each other also. This interlinkage among different health care entities not only facilitates information exchange, but also allows electronic payment for the drugs by the insurance companies to the pharmacies through the PBMs and other financial institutions (not shown). The links among database 320, PBMs 330, insurance companies 340 and pharmacies 350 may be provided by any conventional means such as telephone modem lines.

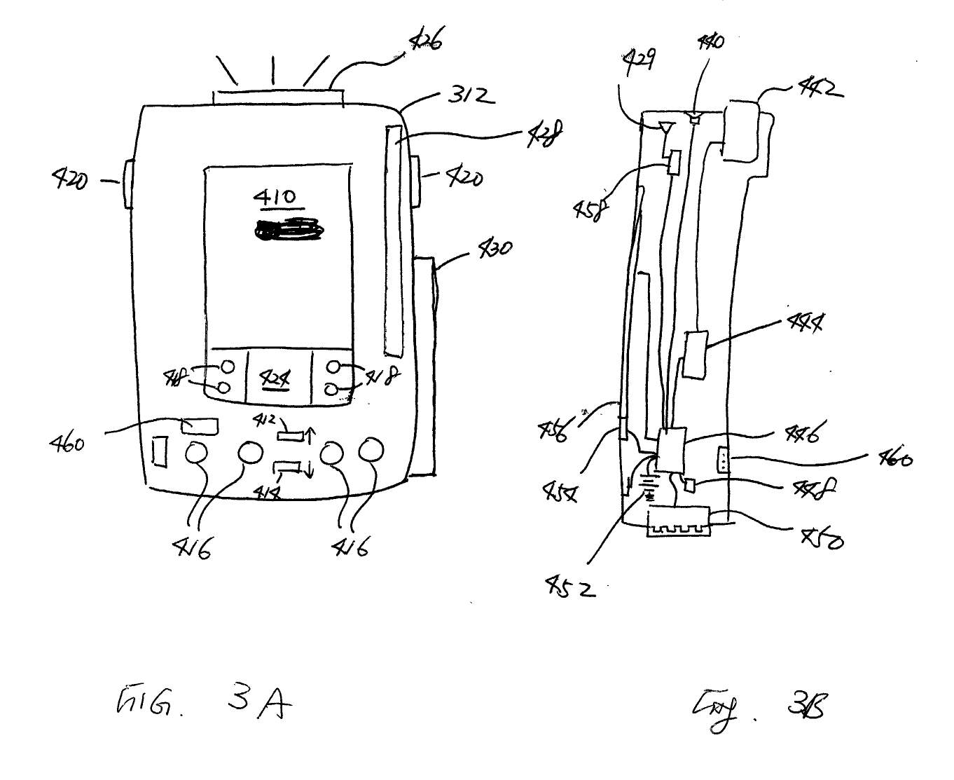

Doctors' offices 310 show terminals 312, which are generally carried around by the doctor from one patient room to the next. The detailed operations of the terminal 312 as it relates to the doctor's prescription writing activities are described in FIGS. 3A, 3B, 4 and 5 with the corresponding text below. Terminals 312 may use a variety of communication links to connect to database 320. For example, terminals 312 may connect to database 320 through various wireless wide area networks such as radio frequency (RF) packet data networks (such as ARDIS, RAM and Mobitex) and cellular digital packet data networks (such as CDPD). However, these wide area networks tend to be relatively expensive. This embodiment is illustrated in FIG. 2, where one of the terminals 312 is shown as linked directly to clearing house 325.

In a second arrangement, the communications link may be provided as follows. The doctor's office may have a base station or an access point (“AP”) 314 for covering the entire doctor's office and for providing a wireless connection to the handheld terminal. In FIG. 2, two of the terminals 312 are shown as linked to AP 314. AP 314 provides access to database 320 through either a telephone connection, cable lines or other known internet connections. AP 314 may also be linked to a computer or a server 316, which may provide additional memory and may run other programs. Having this extra memory and programs may be useful in situations where it is desired to run applications that require more memory and processing powers than the handheld terminal can adequately handle. In addition to providing unlimited access to database 320 at a relatively low monthly cost, using AP 314 provides additional services to terminals 312. For example, terminals 312 may communicate with other terminals on a local area network. For example, one doctor may communicate with another doctor through the terminals via the AP. This communication could take the form of data (e.g., e-mail), voice or graphics. Terminal 312 can optionally perform all the traditional telephone functions (calls, voice mail, paging, etc.) and make calls in a variety of ways—terminal to terminal, terminal to internal phone and terminal to outside phone. For example, the NetVision® phone supplied by Symbol Technologies, the current assignee of this application, provides voice communication over Spectrum 24 network using access points in the 2.4 GigaHertz RF range. A more detailed description of a phone/terminal and the related network that may be used in this invention is found in Symbol's patent application titled, “System For Digital Radio Communication Between A Wireless LAN AND A PBX,” filed Jan. 16, 1998, Ser. No. 09/008,710, which is incorporated herein by reference. The connection may also be through the World Wide Web, which also has the added advantages of providing more functions (e.g., access to the Web sites other than to database 320) to the terminal so that the doctor will be more likely to use it.

In a third arrangement, a terminal 312 is used in a batch mode (that is, without wireless module) and receives the information through a cradle 315, which in turn is linked to a server 316, which has a communications link with clearing house 325. Alternatively, cradle 315 may link directly to a network via a modem like connection. In this embodiment, most of the required information (such as patient roster for a doctor, formulary information for each patient, medical history for each patient) may be downloaded overnight to the local computer 316 at the doctor's office (e.g., overnight) and/or periodically during the day, and this information may be provided to the doctor's terminal wirelessly within the doctor's office. This partial storage of information within the doctor's office makes the information available to the doctor much faster than it would be if the information has to be fetched from the remote, central database. Other information, such as general drug information may still have to be fetched from the remote database. What information needs to be copied over to the doctor's office computer system and how frequently will depend on various factors such as how current the information needs to be, how much data it is and so forth.

Details of and various examples of spread spectrum communication using base stations, access points and portable terminals are disclosed in the following patents assigned to Symbol Technologies, all of which patents are herein incorporated by reference: U.S. Pat. No. 5,815,811; U.S. Pat. No. 5,812,589; U.S. Pat. No. 5,668,803; U.S. Pat. No. 5,528,621; U.S. Pat. No. 5,479,441; U.S. Pat. No. 5,418,812; U.S. Pat. No. 5,280,498; U.S. Pat. No. 5,157,687; U.S. Pat. No. 5,142,550; U.S. Pat. No. 5,103,461; and U.S. Pat. No. 5,029,183.

FIGS. 3A and 3B show one embodiment of terminal 312 in detail. Presently, there are several handheld devices that are widely available. Palm III™ (provided by 3Com), Nino™ (provided by Philips), Cassiopeia™ (provided by Casio) are such examples, and the products names may be trademarks of the respective suppliers. Those devices are generally pen-based in that the data entry is primarily done by tapping or writing on the touch-sensitive display using a pen, rather than using an alphanumeric keypad. Any one of these and other handheld devices may be modified to serve the functions of the terminal required for the present invention.

With reference now again to FIGS. 3A and 3B, portable terminal 312 may include a display 410 for displaying information to the user and a plurality of control keys for permitting the user to interact with display 410. Display 410 not only displays information, but also is touch-sensitive to allow the user to select a displayed icon among a plurality of choices. This “tap to select” feature allows the physician to effectively and conveniently enter the prescription information, as described in more detail below. The control keys can include, for example, up and down scroll keys 412 and 414 respectively. Hard function keys 416 can be included, for example, to call up appointments, e-mails, calendars (with patient appointments, “today's patients,” etc.), telephone list, shopping list, and other notes. One or more touch keys 418 can be provided for purposes of custom applications to allow a soft function approach to interactive program inputs. Separate bar code activation buttons 420 can be used to trigger bar code reading while an additional button 422 can be provided to initiate data transfer on docking in a cradle (not shown) for wired connection with a computer. A region 424 can be provided for purposes of communication via handwriting recognition, for example, for using the so-called “Graffiti Alphabet” of the Palm III™ device. Because the Graffiti Alphabet requires the user to write each alphanumeric character in a very specific fashion, the Graffiti Alphabet provides an efficient mechanism for the physician to “write” in text without the machine having to have the full free-style handwriting recognition, which requires more powerful processors than generally available in handheld devices.

Region 424 or region 410 also provide signature capture capability, capturing a digital representation of a signature. The signature capture capability is important because many states require the physician's signature to be on the prescription. A reader module 426 provides reading capabilities for one and two-dimensional bar codes, such as PDF 417. Alternatively, module 426 may be other types of readers such as RFID tag reader, smart card reader, magstripe reader or other readers. For example, module 430 could be a magstripe reader.

Terminal 312 may further optionally include a wireless transceiver 458 which is coupled to memory 444 and which is configured for wireless communication with an Access Point or for wireless wide area network. Optional transceiver 458 may be provided with a suitable antenna 458 (shown in FIG. 3B) or 428 (shown in FIG. 3A). In one embodiment, the wireless transceiver is either a direct sequencing or frequency spread spectrum working at ranges at or above 900 MHz. One example of such a wireless network is the Spectrum 24® system sold by Symbol Technologies, Inc. Antenna 428 may be pivotally rotatable around one end of the antenna (for example, around the top end) to provide better reception (see FIG. 3A). The positioning of the various components of the terminal shown in FIG. 3A are exemplary only and it will be understood that other configurations are easily obtainable. For example, the magstripe reader may be placed at the bottom portion of the terminal rather than on the right portion as currently shown in FIG. 3A (or on the side, or tethered or connected through IRDA or WLAN). Also, antenna 428 may be positioned in various other places.

Terminal 312 can also include a speaker 440 for supplying audible messages to the user. For example, the audible beep may be used to alert the physician of important message. For example, if a drug about to be prescribed is not covered by the patient's insurance policy (formulary noncompliance). Speaker 440 can also beep when a bar code has been successfully read, and can beep a different tone or pattern of tones when scanning has not been successful. Where voice transmission (as a phone service, voice pager, voice mail or e-mail attachment) is provided, speaker 440 may provide such voice output. Also, a microphone 460 is optionally provided so that the physician may use the terminal as a phone, a recorder or a dictation device. Furthermore, microphone 460 may be connected to a microprocessor for voice recognition and other voice control. Areas 410 and 424 may also optionally provide for biometric identification (such as finger print recognition) for security purposes. The terminal may also have GPS module (or have a separate attachment, which is now widely available for automobile navigation) to provide the location information in a wide area wireless environment.

Terminal 312 also includes a memory 444 coupled to reader module 426 for storing data. Memory 444 could include RAM and also ROM circuitry. Also, a suitable power source 452, for example, suitable dry cell batteries, is provided. Further, a control module 444 can be provided to drive display 410 and to control the operation of the various other components of terminal 312. Further details of the terminal may be found in a copending U.S. patent application, titled “Portable Electronic Terminal and Data Processing System,” filed Jan. 16, 1999, and Ser. No. 09/232,142, which is herein incorporated by reference in its entirety.

FIG. 4 shows sample screens of what a typical prescribing activity will entail in accordance with the principles of the present invention. In a preferred embodiment, the terminal is running an html Internet browser, providing all the benefits of the Internet and interaction offered by the Internet. In referring to FIG. 4, first, in step 510, the physician begins the prescription program and is given a choice between “Prescribe by Drug Type” and “Prescribe by Patient Condition”. It is assumed that before step 510, all the necessary preliminary information, such as the physician's name and other identifying information, and the patient's name, insurance information and other information, is already captured in the terminal. This data capture of preliminary information may be done in a variety of ways. The receptionist may first capture the data and then transfer the data to the physician's terminal or alternatively, the physician may capture the data on the spot as he or she sees the patient. The receptionist may enter the data manually into a computer based on the handwritten information provided by the patient, and this information may be transferred to the physician's handheld terminal wirelessly. Alternatively, the patient may already have a patient card having the information in a machine readable code and the receptionist may scan in the information. Likewise, the physician may capture the preliminary information either manually or automatically by scanning the patient card. The physician's information is inputted into the terminal once and is kept unless modified.

In one embodiment, all of “today's patients and patient data” information may be downloaded to the terminal in the morning or the night before. In this embodiment, the doctor's terminal need not have a radio capability. Instead, the terminal is inserted into a cradle and the information is downloaded to the terminal via the cradle. Examples of such cradles are shown in a copending U.S. patent application, titled “Portable Electronic Terminal and Data Processing System,” filed Jan. 16, 1999, and Ser. No. 09/232,142, which is herein incorporated by reference in its entirety. A flow chart for such a batch mode embodiment (not requiring a wireless link between the handheld terminal and the central database) is illustrated in FIG. 12.

In such a batch mode, the terminal will have to be synchronized once in the morning to download all of that day's patient information (DUR, formulary and so forth). Also, it may be desirable to synchronize the terminal fairly often if the prescription needs to be electronically transferred to the pharmacies (perhaps as often as for every prescription written for a patient). By synchronizing on a periodic basis, not only would the physician be uploading the data (such as the prescription information), but also the physician will be downloading information, such as e-mails, urgent messages, stock quotes, and other desired information.

FIG. 8 is a block diagram of a system comprising a keyboard 810, a monitor 820 and a computer 830 that may be used by a receptionist and/or a pharmacist. The receptionist may use keyboard 810 having a bar code reader 812 and/or a magstripe reader 814 integrally incorporated as part of keyboard 810. Alternatively, the readers may be externally attached to the alphanumeric keyboard. The bar code reader, preferably a two-dimensional reader (either laser-based or imager-based), as shown in FIG. 8, can be located at different places of the keyboard, for example, at the upper right-hand side or upper right-hand side or bottom right hand side, as illustrated in FIG. 8. A magstripe reader may also be located in different places on the keyboard—upper side or on the right-hand side, or any other place as ergonomically convenient. Monitor 820 may be a conventional LCD or CRT type, and the computer may be a standard personal computer. Alternatively, the configuration may be all-in-one type lap top computer.

Returning to step 510 of FIG. 4, the physician may tap either of the two menu icons shown: “Prescribe by Drug Type” or “Prescribe by Patient Condition”. While only two menu icons are shown at step 510, the terminal may easily programmed to show other choices. The menu icons themselves may be presented in other formats and graphical representations. If the “Drug Type” icon is selected, the screen proceeds to step 520, and if the “Patient Condition” icon is selected the screen proceeds to step 522. In step 520, a variety of types of drugs are displayed. While only three drug types are specifically displayed in step 520, it is understood that a dozen or so icons can easily be displayed in one screen (for example, either in a text list format or in a graphical icon format), and this number can easily increase depending on the specific screen format chosen. Given that physicians generally tend to specialize in a few fields of medicine, a few dozen drug types and a few dozen drugs for each drug type, resulting in a total of a few hundred drugs will be sufficient for most physicians' needs. Moreover, the drug selection icons may be presented so that the most often prescribed drug type appears first or in other more prominent fashion. Similarly, in step 522, types of patient condition are displayed so that the physician may find drugs known to be effective for certain patient conditions. In this fashion, the physician may be exposed to new types of drugs that he had been previously unaware of. In steps 530 and 532, the physician selects the particular drug to be prescribed by tapping the icon.

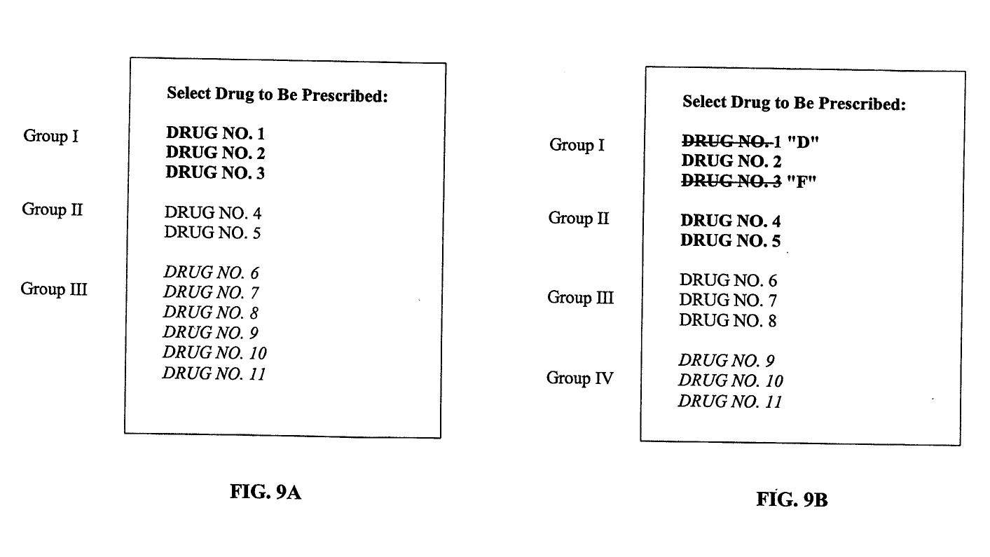

In one embodiment, the drugs being displayed (for example in steps 530 and 532) may already take into account the formulary and DUR information. Thus, at step 530 (or at step 532), the screen may display only the drugs that are on the approved or preferred list according to the formulary guidelines. For example, at step 530, only three antihistamines may be displayed instead of perhaps two dozen widely available antihistamines out on the market. This kind of selective displaying can be further improved by having two or more levels of displaying. For example, in FIG. 9A, the antihistamines most preferred by the insurance companies may be displayed first (Group I (Drug Nos. 1-3)—in one typeface, e.g., highlighted in bold); the ones less preferred, but still approved ones may be displayed second (Group II (Drug Nos. 4 and 5) in another typeface, e.g., in regular font); and the ones not supported by the particular insurance company may be displayed last (Group III (Drug Nos. 6-11) in yet another type face, e.g., in italics). At any point, the physician will be able to override any formulary requirements and prescribe a drug that is not authorized by the insurance company. In such a case, the terminal may provide an audible or visual alarm to the physician to alert him or her that he or she is overriding the insurance recommendation. The same alerting system may be used to inform the physician if the drug about to be prescribed is a “suspect” in terms of formulary, allergies, prior medical history issues.

This type of hierarchical displaying can be further modified to reflect the individual doctor's preference. For example, in Group I above, the doctor's preferred drug is made to appear the first within that group. Alternatively, as shown in FIG. 9B, the groups may be organized completely organized by the doctor's preference. For example, the doctor may want to display his top three antihistamines displayed first regardless of whether they are covered by an insurance company or not. In such a listing, fonts, legends and/or other formatting may be used to indicate the insurance coverage and/or DUR information. Thus, even though the doctor's three preferred antihistamines are displayed on top of the list as Group I (Drug Nos. 1-3), two of them may show up stricken-through with trailing legends “D” for DUR conflict and/or “F” for formulary conflict. In FIG. 9B, Group II shows the drugs approved by the insurance company, Group III the drugs approved but not preferred and Group IV the drugs not approved by the insurance company. While only a few examples are discussed here, the drug listing can be listed, formatted and/or customized in a variety of different ways to suit the individual physician's needs.

FIG. 5 shows one of the final screens of the prescription writing process. Once the drug has been selected—Hytrin in this particular example—the physician proceeds to fill in other relevant information, such as dosage 620, frequency 630, quantity 640, refills 650, other note 660 and the physician's signature 670. Each of these fields may be “handwritten” by the physician (e.g., by using the Graffiti Alphabet or by more general handwriting recognition). Also, these fields may be auto-populated when a drug is selected and default to “typical” or the “usual” prescribing data for that particular drug. Alternatively, these fields may be tapped in. For example, when the “Frequency” field is tapped once, a scroll down menu showing the choices (e.g., 1 mg, 2 mg, 5 mg, 10 mg, 20 mg) may be displayed and the physician simply tap in the selection desired.

In other note field 660, the doctor may indicate other relevant remarks. In the particular example illustrated in FIG. 5, the doctor noted the use of INDOCIN, which under certain circumstance is known to have some side-effects when taken with HYTRIN (the drug being prescribed). The pharmacist when filling the prescription will see the note and understand that the physician was aware of the issue and made a conscious decision to go ahead with HYTRIN. Without the note, the pharmacist, knowing the potential side-effects, would have been reluctant to fill the prescription.

Note that in area 690, the prescription writing program displays information identifying the physician and the patient. This identifying information serves as a reminder to the physician and reduces chances of a patient mix-up. This identifying information need not be exhaustive and can be minimal, just including the patient name and the physician name, for example. Other identifying information (such as the physician's address and the patient's social security number) that generally are written on a prescription need not show up on the screen.

When the physician is done and satisfied with the prescription, he or she may sign his or her name at the space provided for signature 670. In FIG. 5, the signature is shown as being captured in area 410 (see area 410 shown in FIGS. 5 and 3A). However, the signature may be captured in area 424 shown in FIG. 3A as well. Indeed, a relatively high resolution area 424 may be provided for signature capture, the Graffiti Alphabet recognition and other fine recognition requirements; and a relatively low resolution area 410 for general tapping purposes. Having such screen areas with different resolutions may lower the cost and the processing power requirements.

In referring to FIG. 5, note that area 680 is reserved for help, education, advertising or other information. This area may be particularly useful, for example, to alert to the physician information that he or she needs to know before writing the prescription. For instance, in one embodiment, instead of doing the formulary and drug utilization check at steps 530 and/or 532 of FIG. 4, the check may be performed after the physician selects the drug. In this embodiment, the physician selects the drug of his or her choice and then sends the selected drug information to the database. The database will return the formulary and DUR information in response. In addition to bringing this information to the physician's attention, the remote database may be able to suggest one or more alternative drugs that comply with the formulary and/or DUR requirements.

Additionally, area 680 may be used as a general help or information icon, which the physician may tap to request information regarding certain new drugs, statistics and so forth.

Alternatively, the contents of display area 680 may be source-driven in that information and other advertising are sent by drug and other companies and are displayed in area 680, without any request on the part of the physician. For example, important messages such as drug recalls may be disseminated rapidly in this fashion. In one embodiment, such “sponsors” (e.g., a drug company) of area 680 may be willing to provide the terminal to the physician for free in exchange for the physician's willingness to keep the advertising on. Otherwise, the physician will be able to turn the source-driven information either completely off or selectively off (such as programming to receive only certain classes of the source-driven messages “flagged”, for example, as drug recalls, drug side effects and so forth). Such flags or classifications may include: drug recall, drug advertisement and other information. Area 680 may be displayed throughout the prescription writing stages, including, for example, in steps 510 (e.g., general information), 520 (e.g., general information), 522 (e.g., general information), 530 (e.g., drug recalls, any known side effects of a particular drug) and 532 (e.g., drug recalls, any known side effects of a particular drug) of FIG. 4.

FIG. 6 illustrates how the actual prescription may be printed. Once the prescription writing process has been completed and signed off by the physician, the physician may print the prescription in a variety of ways. In one embodiment, a relatively small, low cost printer is provided in each and every patient room so that the physician can wirelessly print from the terminal to the local printer in the room. This way, the physician can make two print-outs of the prescription—one for the patient to take to the pharmacy and the other to go into the patient's folder. The wireless printing may be provided either through RF or infrared. Palm III™, for example, already has an infrared port for wireless communication with other devices. The printer will be equipped with an infrared port. Infrared is particularly useful here because it is effective for short range and yet, due to its low power, line-of-sight and limited range characteristics, it does not cause unwanted interferences with other devices and are subject to very little governmental regulations.

Radio frequency (instead of IR) may also be used for transmission between the terminal and the printer. RF is currently more expensive, but is generally more robust. If RF is used, the transmission can be made directly between the terminal and the printer. Alternatively, the transmission can be made first from the terminal to an access point and from the access point to the printer.

Providing the print-outs during the physician-patient encounter reduces any mix-ups. Also, when the prescription is printed out by the doctor and given to the patient (instead of a receptionist printing out and the patient picking it up on the way out), the patient may be able to ask any questions he or she may have about the prescription on the spot. This concurrency contributes toward better “customer service”. Thus, even in the embodiment using the RF (instead of IR), it is preferable that the printing is done concurrently in the patient room at the time the physician writes the prescription. Also, having the printer in each patient/examination room allows the doctor to conveniently print out important information for the patient's use (e.g., map and directions to a nearby pharmacy), as well as for the doctor's use (e.g., important e-mails that the doctor may keep a hard copy of in his or her pocket as a reminder).

In addition to (or instead of) just printing the prescription, the prescription may be sent electronically to a pharmacy of choice. Here, the signature capture capability is particularly useful since many states currently require the physician's signature on the prescription. This way, the drug will be ready for pick up by the time the patient arrives at the pharmacy. Even in the electronic transmission, it may still be helpful for added security (and legally required in many states) to require the patient to bring a physical copy of the prescription in person when he or she picks up the drug prescribed.

The pharmacy may be selected by the patient and the patient may already know its location. On the other hand, the patient may not know of one nearby and the physician may be able to suggest one to the patient. In this case, the terminal will also be able to provide the address and directions to the pharmacy, either in the form of text and/or in a map. The directions and the map may also be printed out for the patient. The physicians may arrange with certain pharmacies to have the pharmacies provide discounts to the referring physicians' patients.

It may also be beneficial to have two-tier arrangement, wherein the short-term need is filled by a local pharmacy and the more long-term need is provided by a less expensive, mail order pharmacy. For example, after the prescription has been finalized (as shown in FIG. 5), the terminal may ask the physician and the patient with the following choices: (1) fill the prescription at a local pharmacy; (2) fill the prescription partly at a local pharmacy and partly by mail order; (3) fill the prescription by mail order. If item (1) is selected, then the terminal displays a list of local pharmacies, with a map if needed and/or directions thereto. If item (3) is selected, the patient may have the option to pick the mail order company. Also, the patient will have to provide credit card information so that the portion he or she is responsible can be billed.

The portion that the patient's insurance company is responsible for will be adjudicated through the PBM as described above in conjunction with FIG. 2. If item (2) is selected, then a combination of (1) and (3) will be done. Such a two-tier arrangement will provide significant savings for both the individual patients as well as reduce the overall health care cost.

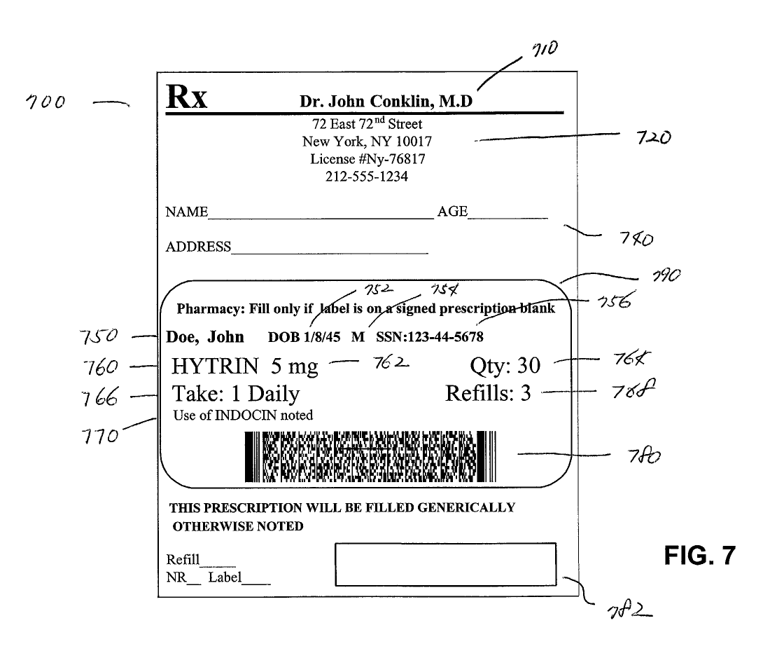

FIG. 7 shows a sample of what an actual prescription would look like when it is printed out by the local printer in the patient room as described above in FIG. 6. The entire prescription form may be printed by the printer or alternatively, only a self-adhesive label 790 containing the prescription information may be printed. In case the self-adhesive label is used, the physician's name 710 and other physician information 720 such as address and license number are generally preprinted on the prescription form. Printing the prescription on an adhesive label also has the added advantage because the label will last longer than the regular paper, and the prescription can be saved by the pharmacy for a longer period (several years required in most states). The physician also may hand-write in the name of the patient and other patient information such as the age and address. However, most of the patient information is printed on the label and thus, the hand-writing would not be minimal.

On label 790 are patient name 750, date of birth 752, sex 754, social security number (or other patient identifying number) 756, name of the drug 760, dosage 762, quantity 764, frequency 766, refill information 768, and other note 770. Additional information (not shown in the figure) may include patient's address and patient's insurance company name, patient's insurance company's phone number for the modem connection, patient age and other drug utilization or allergy information. All of this prescription-related information is printed legibly to the human eye. At the same time, all of this prescription-related information is also printed in a machine readable code 780. Several types of codes may be used: two dimensional bar code such as PDF 417, RFID tag, smart card, or other suitable code.

PDF 417 is the current preferred embodiment and currently has the following advantages: it can easily be printed by a regular, inexpensive printer (e.g., ink jet, dot matrix, laser) and hence very cheap to print; it provides enough information density (up to a few thousand characters in the space generally available); it provides enough error correction so that significant portions of the data may be randomly lost, but still all of the data being recoverable. A more detailed discussion of the PDF 417 Symbology is provided in “A PDF 417 Primer: A Guide to Understanding Second Generation Bar Codes and Portable Data Files,” Monograph 8, Symbol Monograph Series, April 1992, Stuart Itkin and Josephine Martell, which is herein incorporated by reference. Details of the printing, encoding and decoding and reading the PDF 417 bar codes are disclosed in the following patents assigned to Symbol Technologies, Inc. and are herein incorporated by reference: U.S. Pat. No. 5,304,786; U.S. Pat. No. 5,399,846; 5,504,322; U.S. Pat. No. 5,19,181; U.S. Pat. No. 5,337,361; and U.S. Pat. No. 5,489,158. PDF 417 bar code labels may be read with a laser-based reader or an imager such as a CCD imager or a CMOS imager.

In the alternative, a smart card may be used instead of PDF 417. A smart card, generally about the size of a credit card, can store individual medical histories, and such portable storage is useful for reasons discussed above. While it is more expensive, smart cards generally can store large amounts of information. Thus, in applications requiring large amounts of data, smart cards may be useful. U.S. Pat. No. 5,832,488 discloses examples of such smart cards and is herein incorporated by reference. In the smart card embodiment, the prescriber may obtain the DUR, formulary and other medical information from the patient's smart card, and process the information much the same way discussed above. When the physician is ready to finalize the prescription, the physician, in addition to or in lieu of printing (or sending electronically to a pharmacy), may electronically write the prescription onto the patient's smart card. The patient then may take the smart card to the pharmacy for the drug to be filled. The pharmacist will fill the prescription and indicate that on the smart card so that the patient cannot get multiple fills on the same prescription.

Signature box 782 contains the physician's signature. This signature may be an actual signature, or may be a print-out of the physician's electronic signature captured in the terminal. In one embodiment, the pharmacies may have on their computers copies (either actual or electronic) of the physicians' signatures. Thus, the pharmacist, as an added security measure, may compare the physician's signature on the prescription with the physician's signature on file at the pharmacy before releasing the drug to a patient. Alternatively, the physician's signature may be encoded in the PDF label in addition to an actual signature on the prescription. In this embodiment, the pharmacist when he or she scans the PDF label will see the physician's signature on the screen and be able to compare that “electronic” signature with the actual signature on the prescription for authentication purposes.

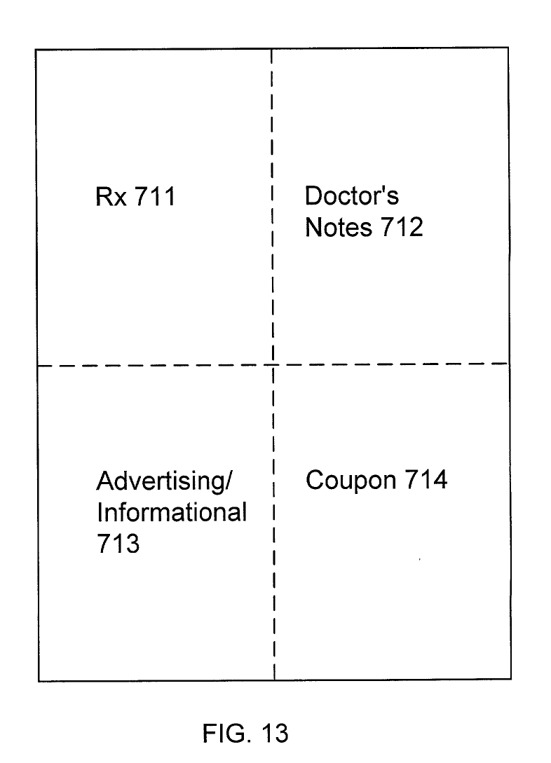

FIG. 13 shows another embodiment of what the prescription print out may look like. The print-out would have four sections: Rx (prescription) section 711, Doctor's notes section 712, advertising section 713 and coupon section 714. The paper may be regular 8.5′ by 11″ paper with four perforated sections. Rx section 711 will carry essentially the same information as shown on the prescription of FIG. 7. Doctor's notes section 712 will show what the doctor's office would like to put in, such as any web site they may have, any 24 hour service available, basically any information the doctor may want to put in. Advertising/informational section 713 may show drug related information. For example, it may discuss benefits, potential side effects of the particular drug being prescribed. Coupon section 714 may be from the pharmacy chosen by the patient. This coupon section may include a bar code label (preferably a PDF 417) for ease of administration at the pharmacy. The coupon section may also provide the directions to the pharmacy of choice from the physician's office.

It will be apparent to those skilled in the art that various modifications and variations can be made in the systems and methods in accordance with the principles of the present invention without departing from the scope or spirit of the invention.

For example, in one variation, the physician may use the handheld terminal of the present invention to record what the physician has been recording traditionally on the super bill (see FIG. 10). As described above in conjunction with FIGS. 1A and 10, the doctor now can record on the handheld terminal the codes (e.g., CPT codes) for the procedures performed and the codes (e.g., ICD-9 codes) for the diagnoses for the patient conditions. These codes can be sent over to the insurance companies (or clearing houses therefor) for quicker and more accurate processing. Note that because the terminal is connected to the remote central database, the doctor has at the time of the patient encounter more information for billing purposes. For example, certain procedures may be authorized only for certain diagnoses. For example, if the procedure performed was sigmoidoscopy and if the doctor noted a diagnosis of abdominal pain, then the insurance company may refuse payment, where as a diagnosis of diverticulitis would authorize the procedure. One way to input the diagnosis/procedure codes into the handheld terminal would be to begin by entering diagnosis (similar to entering the type of drugs in step 520 of FIG. 4). Then the terminal would display authorized procedures for that diagnosis (similar to the list of available drugs in step 530 of FIG. 4). This list of authorized procedures according to the diagnosis varies from insurance company to insurance company. Conversely, the physician may begin by first entering the procedure, then the terminal would display a list of diagnoses that would support the particular procedure being ordered by the physician. This way, the doctor can properly document his or her procedures and diagnoses consistent with the insurance requirements, obviating the frustrating resubmission of the insurance bill.

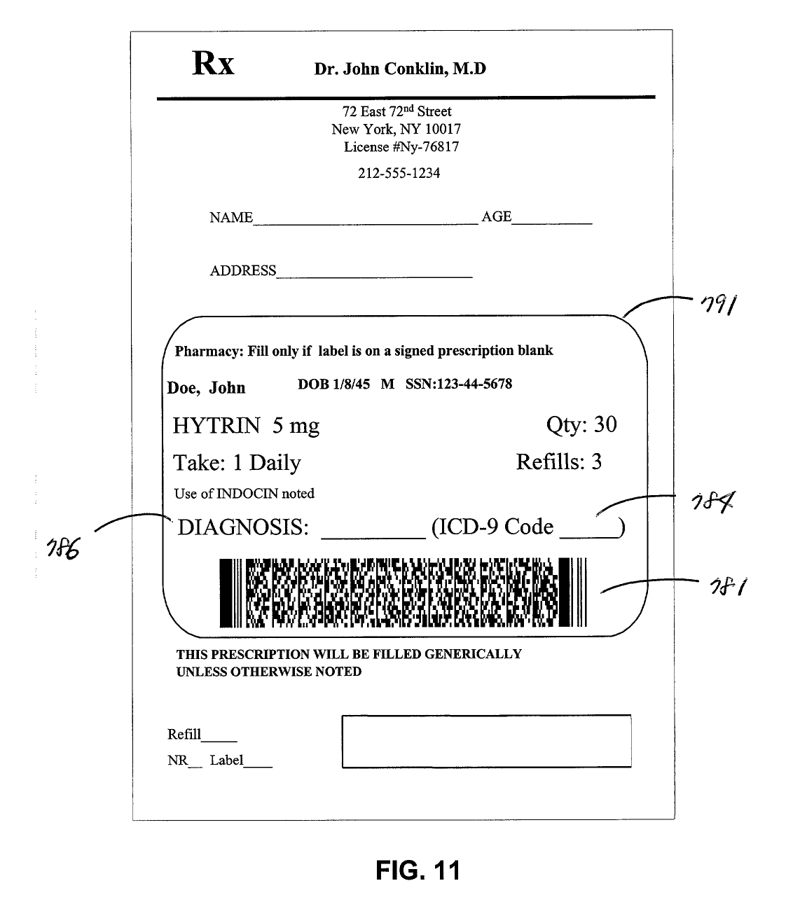

In another variation, in the prescription shown in FIG. 11, label 791 may include the physician's diagnosis information 786 and the corresponding diagnosis code 784 (such as ICD-9 code) both in human readable form and in machine readable form 781. Correlating the drug being prescribed with the diagnosis and providing this information in machine readable form offer several advantages.

First, providing this correlation information may allow the insurance company to selectively allow certain drugs to be used only with certain diagnoses. For example, a drug insurance company may be willing to pay for an expensive drug X only for diagnoses A, B and C, but not for diagnosis D and E. In this embodiment, each diagnosis (for a particular insurance company and the patient) will give a list of authorized drugs that the physician can prescribe (see, e.g., step 520 or 522 and 530 or 532 of FIG. 4). Conversely, when a drug is selected by the physician (such as in step 530 or 532 in FIG. 4), the next screen will give a list of authorized diagnoses and prompt the physician to select the diagnosis. Allowing the insurance company to control dispensing of expensive drugs in such a selective manner may lower the overall health care costs.

Second, the information prescribed drug according to the diagnosis on a systematic basis, particularly tied to the diagnosis codes (such as ICD-9 codes) has tremendous importance medically and commercially. Medically, the physicians will know which drugs are effective for which medical conditions. Commercially and research-wise, drug companies can use this information (drug efficacy and outcomes) to more successfully distribute drugs and fine tune their research.

Third, having the drug/diagnosis information on a machine readable form will expedite drug insurance claim submission and adjudication at the pharmacy. Without such ease of entry of the required information particularly at the pharmacy, the systematic collection of drug/diagnosis will be difficult to implement.

In a further variation, the machine readable code may also include the procedure performed by the doctor with the corresponding code (such as the CPT code). This way, the machine readable code on the prescription has three insurance related information: (1) prescription information itself; (2) diagnoses; and (3) procedures (performed by the doctor or other medical personnel). Having all three of these (or some of these) in one machine readable code can simplify insurance processing and allows integration of medical insurance processing with prescription drug insurance processing.

In yet another variation, it is contemplated that many of the prescription activities will be voice activated and/or otherwise voice controlled. For example, instead of the tap and select process illustrated in FIGS. 4 and 5, the physician may begin by saying a command to the handheld terminal such as “INITIATE PRESCRIPTION”. Then the physician may say, “SELECT DRUG TYPE”, followed by “ANTIHISTAMINE” (see step 520 of FIG. 4), and then “ACCEPT”. Then the physician will say “SELDANE” (or whatever the actual name of the drug may be) and “ACCEPT”. Then, the physician will continue with “DOSAGE”, “5 mg”, “ACCEPT” . . . “PRINT PRESCRIPTION” and so forth until done. The drug formularies and DUR check will be performed similar to the way already described, and either visual or audible warnings and/or other information may be provided. For added protection, the handheld terminal may be trained to recognize only the particular physician's voice. Indeed, “training” the terminal to recognize one individual's voice lessens the processing requirements too.

In yet another embodiment, the terminal is equipped with biometric identification, such as finger print recognition. This feature is particularly important in the field of prescription generation. The terminal with the sensitive patient information and with the prescription generation capabilities could be dangerous in the wrong hands. Having the biometric identification allows the terminal to be used by only the authorized prescriber. The terminals actually may be stored in the cradles in a locked position and the terminals may be released for the physician's use only when the physician is properly identified through the biometric identification. For examples of cradles (four-slot, stackable cradles) that may be used, see copending U.S. patent application, titled “Portable Electronic Terminal and Data Processing System,” filed Jan. 16, 1999, and Ser. No. 09/232,142, which is herein incorporated by reference in its entirety. Such a cradle embodiment may allow recordation of who took out a terminal last and when for security purposes. The terminal turn itself off after certain designated period of inactivity and will be turned on only after the biometric authentication. This biometric identification may be used in addition to or independently of the usual password protection.

In another embodiment addressing security concerns, the terminal may be activated only upon reading a prescriber badge with identification information. For example, the badge may have a bar code (preferably PDF 417 and/or encrypted), RFID tag, smart card, magstripe or other identifying means that can be scanned by the terminal. Thus, the terminal can be accessed only by a person holding the authorized badge. Security protection by means of a badge is generally more secure than the general password protection. Under either the biometric embodiment or the badge embodiment, if an unauthorized access to the terminal has been attempted, it may be desirable to have the terminal begin beeping to alert the authorized user of this fact.

In yet another security feature, the terminal may turn itself off as soon as it has been removed beyond the authorized area (such an area may be defined by the RF reach of an access point). For example, if an unauthorized person removes the terminal from the doctor's office, the terminal will shut itself off and begin beeping loudly until the terminal is returned to the authorized premises.

In yet another embodiment, the portable terminal has GPS capabilities so that the location of the terminal can be identified. This feature is particularly important in situations where the portable terminal may be taken to different states in a wide area wireless environment. For example, a physician licensed in New York would not be authorized to generate prescriptions while visiting in New Jersey. Also, even if a doctor is licensed in both states (New York and New Jersey, for example), the doctor may not be allowed to prescribe certain drugs in one state and vice versa. Thus, the positive location identification of the physician in a mobile, wireless environment is critical to the widespread use of electronic prescription. The physician location at the time of the prescription generation may have to be recorded by the clearing house and/or recorded on the prescription being given to the patient.

The combination of the biometric identification of the physician and the positive location identification of the physician using GPS would enable a secure wide area network prescription generation transactions—ability to confirm that the authorized physician is prescribing from the authorized location jurisdiction) is essential to the success of wide area network prescription generation.

In yet another embodiment, the physician may use the handheld terminal as a phone to check the DUR, formulary and other medical information, instead of (or as a supplement to) using the browser. This is possible because as shown in FIG. 3A and described in the corresponding text and the copending application, “Portable Electronic Terminal and Data Processing System,” filed Jan. 16, 1999, and Ser. No. 09/232,142, the terminal in one embodiment of the present invention includes an Internet phone, which could be used to call another Internet phone or a regular phone. The phone could also be used to call the pharmacy ahead to check the availability of the drug being prescribed. Because the terminal has the built in security features, such as biometric identification, and therefore self-authenticating, the clearing house personnel or the pharmacy personnel will be able to provide confidential patient-specific to the physician.

It will be understood all of the features discussed above can be made optional to the user. For example, the physician will be given the choice of turning on the DUR and/or formulary compliance check, or receipt of the advertising on the terminal.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer aided method of generating a medication prescription, comprising:
(a) entering a medication prescription into a terminal;
(b) checking at the point of prescribing the medication prescription with a database for formulary compliance;
(c) printing the prescription recorded in the terminal in a machine readable code on a printer connected to the terminal by infrared; and
(d) automatically scanning the machine readable code at a pharmacy to fill the prescription.

2. The method of claim 1, further comprising the step of:
authenticating the identity of a prescribing physician through biometric identification means in the terminal before the step of entering a medication prescription into the terminal.

3. The method of claim 1, further comprising the step of:
identifying the location of a prescribing physician through a GPS locator in the terminal before the step of entering a medication prescription into the terminal.

4. The method of claim 1, wherein the step of entering the medication into the terminal is performed by voice activation.

5. The method of claim 1, wherein said machine readable code comprises a two dimensional bar code.

6. The method of claim 1, wherein said machine readable code comprises a PDF 417.

7. The method of claim 1, wherein said machine readable code is encoded in a smart card.

8. The method of claim 1, wherein the step of printing further includes printing the prescriber's signature in a machine readable code form and wherein the before the prescription is filled at the pharmacy, the prescriber's signature in a machine readable code form is compared with an actual signature on the prescription for authentication purposes.

9. A computer aided method of generating a medication prescription, comprising:
(a) entering a medication prescription and a diagnosis into a terminal;
(b) checking at the point of prescribing the medication prescription with a database for formulary compliance; and
(c) printing the prescription and the diagnosis recorded in the terminal in a machine readable code on a printer.

10. The method of claim 9, further comprising:
automatically scanning the machine readable code at a pharmacy to fill the prescription.

11. The method of claim 9, wherein the step of checking at the point of prescribing with the database further includes checking to determine if a prescribed drug meets the formulary compliance for said diagnosis.

12. A computer aided method of generating a medication prescription, comprising:
(a) entering a medication prescription and a diagnosis into a terminal;
(b) printing the prescription including the drug information and the diagnosis recorded in the terminal in a machine readable code on a printer.

13. The method in accordance with claim 12, further comprising:
checking at the point of prescribing formulary compliance before generating the medication prescription.

14. The method in accordance with claim 12, further comprising:
checking at the point of prescribing the patient's medical history before generating the medication prescription.

15. The method in accordance with claim 12, wherein the step of entering further includes entering a medical procedure into a terminal and wherein the step of printing further includes printing the medical procedure information in a machine readable code.

16. A computer aided method of generating a medication prescription, comprising:
(a) scanning in a machine readable code having information regarding a patient related information for prescription writing purposes, including drug formulary information; and
(b) generating a medication prescription in accordance with the information derived from said machine readable code.

17. The method in accordance with claim 16, wherein said machine readable code comprises a two dimensional bar code.

18. A system for generating a medication prescription, comprising:
(a) a computer including a database, said database comprising:
a list of participating insurance carriers,
a list of members for each of the participating insurance carriers, and
a list of drugs approved for each member by each of the participating insurance carriers;
(b) a communications link;
(c) a terminal communicating with the computer through the communications link, said terminal including:
input means for a prescriber to enter a prescription,
a first communication module for communication with the computer through the communications link,
a second communication module, and
a terminal software for allowing the prescriber to enter patient data, a desired prescription and to communicate the patient data to the computer and return information to said terminal and display the information; and
(d) a printer for printing the prescription including the drug information in a machine-readable code, said printer wirelessly communicating with the terminal through the second communication module.

19. The system as claimed in claim 18, wherein the terminal software selectively displays a list of drugs according to whether the drugs are approved by the insurance company.

20. The system as claimed in claim 18, wherein said database further includes:
(a) a medical history of each member, said medical history including one or more of the following:
drugs being taken by the member,
drugs known to be allergic to the member, and
other medical history information; and
(b) a relational database of drug interactions.

21. The system as claimed in claim 20, wherein the terminal alerts the prescriber when the prescriber attempts to prescribe a drug that may have adverse medical consequences given the member's medical history.

22. The system as claimed in claim 18, wherein the communications link comprises an access point.

23. The system as claimed in claim 18, wherein the communications link comprises a wireless wide area network communications link.

24. The system as claimed in claim 18, wherein said terminal comprises a handheld terminal.

25. The system as claimed in claim 18, wherein the input means of said terminal includes means for capturing a signature.

26. The system as claimed in claim 18, wherein said database includes educational information regarding drugs, which educational information is accessible to the prescriber using the terminal.

27. The system as claimed in claim 18, wherein said first communication module is said second communication module.

28. The system as claimed in claim 18, wherein said second communication module comprises an infrared communications module.

29. The system as claimed in claim 18, wherein said machine-readable code comprises a two dimensional bar code.

30. The system as claimed in claim 18, wherein said machine-readable code comprises a PDF 417.

31. The system claimed in claim 18, wherein said machine-readable code includes information on the prescribed drug, dosage and amount.

32. The system as claimed in claim 18, wherein said machine-readable code is embedded in a smart card.

33. The system as claimed in claim 18, wherein said terminal includes a bar code reader.

34. The system as claimed in claim 18, wherein said terminal includes a telephone unit.

35. The system as claimed in claim 18, wherein said terminal includes a voice recognition unit.

36. The system as claimed in claim 18, wherein said terminal includes a biometric identification unit.

37. The system as claimed in claim 18, wherein said terminal includes a GPS locator unit.

38. A system for generating a medication prescription, comprising:
(a) a pen-based handheld terminal, including:
input means for an authorized prescriber to enter a prescription and for capturing
the prescriber's signature and
a wireless module; and
(b) a printer for printing the prescription including the drug information in a machine-readable code, said printer wirelessly communicating with the terminal through the wireless module.

39. The system as claimed in claim 38, wherein said machine-readable code comprises a PDF 417.

40. The system as claimed in claim 38, wherein said printer communicates with the terminal by infrared.
